(19) United States
(12) Patent Application Publication
(10) Pub. No.: US 2019/0301590 A1
(43) Pub. Date: Oct. 3, 2019

(54) GEAR REDUCTION DEVICE HAVING POSITIONING ASSEMBLY

(71) Applicant: Ta Chuang WEI, Taichung City (TW)

(72) Inventor: Ta Chuang WEI, Taichung City (TW)

(21) Appl. No.: 15/937,041

(22) Filed: Mar. 27, 2018

(51) Int. Cl. F16H 57/021; F16H 1/20; F16H 57/031; F16H 57/029

(52) U.S. Cl. CPC F16H 57/021; F16H 1/20; F16H 2057/02034; F16H 57/029; F16H 57/031

(57) ABSTRACT

A gear reduction device having a positioning assembly contains: a gear box, a drive motor, an accommodation box, and a braking device. The gear box is connected with the drive motor and accommodates at least one gear set, the braking device is electrically connected with the drive motor, and the accommodation box is disposed outside the drive motor. The positioning assembly is located on a top of the gear reducer and includes a driving gear, a driven gear, a fixing gear, a support plate, a screw rod, and multiple limit switches. The driving gear is connected on the gear box, and the driven gear is fixed on the gear box and meshes with the driving gear. The screw rod is mounted on the support plate, connects with the fixing gear, and meshes with the driven gear. The multiple limit switches are disposed on the support plate.

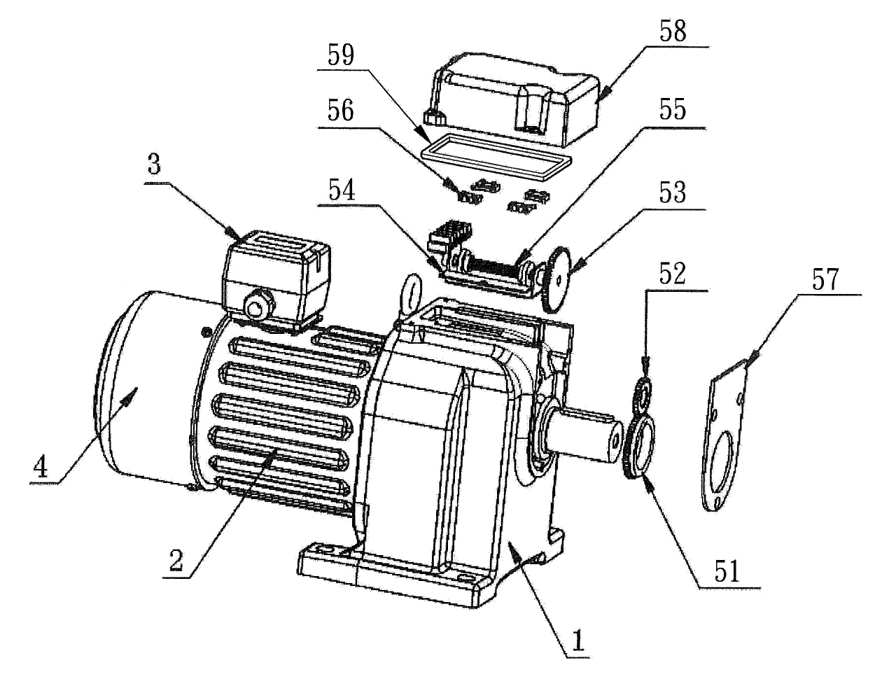

### FIELD OF THE INVENTION

The present invention relates to a gear reduction device having a positioning assembly which is simplified, prolongs service life, and is maintained easily.

### BACKGROUND OF THE INVENTION

A conventional gear reduction device is complicated, has short service life, and is fixed in a large space. Furthermore, the conventional gear reduction device cannot operate in high temperature and humidity.

The present invention has arisen to mitigate and/or obviate the afore-described disadvantages.

### SUMMARY OF THE INVENTION

The primary objective of the present invention is to provide a gear reduction device having a positioning assembly which is simplified, prolongs service life, and is maintained easily.

Secondary objective of the present invention is to provide a gear reduction device having a positioning assembly which is mounted efficiently in a small space.

Further objective of the present invention is to provide a gear reduction device having a positioning assembly which operates in a temperature of 40° C. to 100° C. and a humidity of at least 80%.

Another objective of the present invention is to provide a gear reduction device having a positioning assembly which is produced at a low fabrication cost.

To provide a gear reduction device having a positioning assembly provided by the present invention contains: a gear box, a drive motor, an accommodation box, and a braking device.

The gear box is in connection with the drive motor so as to form a transmission mechanism, the gear box accommodates at least one gear set, the braking device is electrically connected with a distal end of the drive motor, and the accommodation box is disposed outside the drive motor.

The positioning assembly is located on a top of the gear reducer, and the positioning assembly includes a driving gear, a driven gear, a fixing gear, a support plate, a screw rod, and multiple limit switches.

The driving gear is connected on an output shaft of a front end of the gear box, and the driven gear is fixed on the gear box by way of at least one screw and meshes with the driving gear, the screw rod is mounted on the support plate, connects with the fixing gear, and meshes with the driven gear by using the at least one screw, wherein the multiple limit switches are disposed on the support plate by using the at least one screw.

Preferably, the positioning assembly further includes a protective cap and a case, the protective cap is mounted on the gear box by way of the at least one screw, and the case is fixed on the gear box by using the at least one screw.

Preferably, a washer is defined between the protective cover and the gear box.

### BRIEF DESCRIPTION OF THE DRAWINGS

The Sole FIGURE is a perspective view showing the exploded comments of a gear reduction device having a positioning assembly according to a preferred embodiment of the present invention.

### DETAILED DESCRIPTION OF THE PREFERRED EMBODIMENTS

With reference to the sole FIGURE, a gear reduction device having a positioning assembly according to a preferred embodiment of the present invention comprises: a gear reducer arranged on a front end of the gear reduction device, the positioning assembly located on a top of the gear reducer and connecting with an output shaft, a drive motor 2 connecting with the gear reducer and a barking device 4, an accommodation box 3 disposed outside the drive motor 2 and configured to accommodate power terminals, and the braking device 4 electrically connected with a distal end of the drive motor 2, wherein the positioning assembly is one piece formed with the gear reducer so as to avoid damage during transportation.

Substantially, the gear reduction device comprises a gear box 1, a drive motor 2, the accommodation box 3, the braking device 4, and the positioning assembly. The positioning assembly includes a driving gear 51, a driven gear 52, a fixing gear 53, a support plate 54, a screw rod 55, multiple limit switches 56, a protective cap 57, a case 58, and a washer 59. The gear box 1 is in connection with the drive motor 2 so as to form a transmission mechanism, and the gear box 1 accommodates at least one gear set. The braking device 4 is electrically connected with a distal end of the drive motor 2, and the accommodation box 3 is disposed outside the drive motor 2. The driving gear 51 is connected on the output shaft of a front end of the gear box 1, and the driven gear 52 is fixed on the gear box 1 by way of at least one screw (not shown) and meshes with the driving gear 51. The screw rod 55 is mounted on the support plate 54, connects with the fixing gear 53, and meshes with the driven gear 52 by using the at least one screw, wherein the support plate 54 is secured on the gear box 1 by way of the at least one screw. The multiple limit switches 56 are disposed on the support plate 54 by using the at least one screw, the protective cap 57 is mounted on the gear box 1 by way of the at least one screw, and the case 58 is fixed on the gear box 1 by using the at least one screw, wherein the washer 59 is defined between the protective cover 58 and the gear box 1 so as to seal the positioning assembly and the gear box 1 matingly.

After supplying power to the gear reduction device, the positioning assembly operates forward so that the driving gear 51 drives the driven gear 52 and the fixing gear 53 to rotate, and the screw rod 55 is driven by the driven gear 52 and the fixing gear 53 to revolve, thereafter limiting terminals on the screw rod 55 contact with some of the multiple limit switches 56 on a first end of the support plate 54 so as to power off the gear reduction device. After supplying the power to the gear reduction device again, the positioning assembly operates reversely so that the screw rod 55 rotates and its limiting terminals contact with the other limit switches 56 on a second end of the support plate 54, thus powering off the gear reduction device.

In this embodiment, two limit switches 56 are arranged on the first end of the support plate 54, and the other two limit switches 56 are arranged on the second end of the support plate 54, such that when the two limit switches 56 are failed, the other two limit switches 56 still work so as to enhance using safety of the gear reduction device.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A gear reduction device having a positioning assembly comprising:
a gear box, a drive motor, an accommodation box, and a braking device; the gear box being in connection with the drive motor so as to form a transmission mechanism, the gear box accommodating at least one gear set, the braking device being electrically connected with a distal end of the drive motor, and the accommodation box being disposed outside the drive motor, wherein
the positioning assembly is located on a top of the gear reducer, and the positioning assembly includes a driving gear, a driven gear, a fixing gear, a support plate, a screw rod, and multiple limit switches;
wherein the driving gear is connected on an output shaft of a front end of the gear box, and the driven gear is fixed on the gear box by way of at least one screw and meshes with the driving gear, the screw rod is mounted on the support plate, connects with the fixing gear, and meshes with the driven gear by using the at least one screw, wherein the multiple limit switches are disposed on the support plate by using the at least one screw.

2. The gear reduction device claimed in claim 1, wherein the positioning assembly further includes a protective cap and a case, the protective cap is mounted on the gear box by way of the at least one screw, and the case is fixed on the gear box by using the at least one screw.

3. The gear reduction device claimed in claim 1, wherein a washer is defined between the protective cover and the gear box.
